(19) United States
(12) Patent Application Publication
(10) Pub. No.: US 2005/0262485 A1
(43) Pub. Date: Nov. 24, 2005

(54) Duplicate merge avoidance in parallel development of interdependent semi-derived artifacts

(75) Inventor: Frederic Plante, Chelsea (CA)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: International Business Machines Corporation, Armonk, NY (US)

(21) Appl. No.: 10/872,934

(22) Filed: Jun. 21, 2004

Related U.S. Application Data
(63) Continuation-in-part of application No. 10/849,294, filed on May 19, 2004.

(51) Int. Cl. G06F 9/45

(52) U.S. Cl. 717/136; 717/122; 717/104

(57) ABSTRACT

Described is a method for merging artifacts in a parallel development of interdependent semi-derived artifacts. A combination of forward engineering, reverse engineering and merge operations are used to avoid duplication in resolving conflicting semantic changes encountered during conventional delivery of the artifacts to an integration stream. According to the method, local changes to the artifacts are visible to users of the integration stream and intermediate merge operations are performed.

### RELATED APPLICATION

This application is a continuation-in-part application claiming priority to co-pending U.S. patent application Ser. No. 10/849,294, filed May 19, 2004, titled “Method for Synchronization of Concurrently Modified Interdependent Semi-Derived Artifacts,” the entirety of which application is incorporated by reference herein.

### FIELD OF THE INVENTION

The invention relates generally to the parallel development of interdependent semi-derived artifacts. In particular, the invention relates to a method that avoids duplication of conflict resolutions in parallel development environments.

### BACKGROUND OF THE INVENTION

As computer systems software becomes more complex, software analysts and architects often rely on models to represent the software. Tools have been developed to operate on a model of the software to generate the software code (e.g., Java, C++). The model may be created, for example, using Unified Modeling Language (UML). The software model and the generated code exist as files or “artifacts”. Code is generated from the software model in a forward engineering operation. The code can be modified and a reverse engineering operation can be used to update the software model to account for the code modifications.

In a common scenario, a software model is developed and code is then generated from the model. Subsequently, the code is modified and then the software model is transformed according to the intervening changes in the code. This process is repeated until the final. code version is achieved. Many developers can have access to the software model and code available through an integration stream. This parallel development capability allows developers to independently make changes to the model and code before returning the modified versions of model and code to the integration stream. Consequently, the model and code modified by one developer and delivered (i.e., returned) to the integration stream can conflict with the model and code delivered to the integration stream by another developer. The conflicts (e.g., delete/change conflicts) are managed by performing a merge operation using the two software models and another merge operation using the two codes. Thus each conflict is handled twice, once in the model merge and once in the code merge. Depending on the number of conflicts, the required processing can be significant.

What is needed is a method for merging artifacts in a parallel development environment that avoids duplicate resolution of conflicts. The present invention satisfies this need and provides additional advantages.

### SUMMARY OF THE INVENTION

In one aspect, the invention features a method for merging artifacts in a parallel development of a first artifact and a second artifact. The first and second artifacts are interdependent semi-derived artifacts each having a plurality of elements. A temporary version of the first artifact is generated and has a merge of elements from a local version of the first artifact to be delivered to an integration stream and a latest integrated version of the first artifact. A first temporary version of the second artifact is generated and includes all the elements of a latest integration version of the second artifact and all the elements of the temporary version of the first artifact transformed as the second artifact. A second temporary version of the second artifact is generated and includes all the elements of a local version of the second artifact to be delivered to the integration stream and all the elements of the temporary version of the first artifact transformed as the second artifact. A new integrated version of the second artifact is generated and includes a merge of the elements in the first and second temporary versions of the second artifact. In one embodiment, the method also includes generating a new integrated version of the first artifact having all the elements of the temporary version of the first artifact and all the elements of the new integrated version of the second artifact transformed as the first artifact, wherein the new integrated version of the first artifact is synchronized with the new integrated version of the second artifact.

In another aspect, the invention features a computer program product for use with a computer system. The computer program product includes a computer useable medium having embodied therein program code for processing integrated versions and local versions of a first artifact and a second artifact. The first and second artifacts are interdependent semi-derived artifacts each having a plurality of elements. The computer program product includes program code for generating a temporary version of the first artifact having a merge of elements from a local version of the first artifact to be delivered to an integration stream and a latest integrated version of the first artifact, and program code for generating a first temporary version of the second artifact having all the elements of a latest integration version of the second artifact and all the elements of the temporary version of the first artifact transformed as the second artifact. The computer program product also includes program code for generating a second temporary version of the second artifact having all the elements of a local version of the second artifact to be delivered to the integration stream and all the elements of the temporary version of the first artifact transformed as the second artifact, and program code for generating a new integrated version of the second artifact having a merge of the elements in the first and second temporary versions of the second artifact.

In another aspect, the invention features a computer data signal embodied in a carrier wave for use with a computer system. The computer data signal includes program code for processing integrated versions and local versions of a first artifact and a second artifact. The first and second artifacts are interdependent semi-derived artifacts each having a plurality of elements. The computer data signal includes program code for generating a temporary version of the first artifact having a merge of elements from a local version of the first artifact to be delivered to an integration stream and a latest integrated version of the first artifact, and program code for generating a first temporary version of the second artifact having all the elements of a latest integration version of the second artifact and all the elements of the temporary version of the first artifact transformed as the second artifact. The computer data signal also includes program code for generating a second temporary version of the second artifact having all the elements of a local version of the second artifact to be delivered to the integration stream and all the elements of the temporary version of the first artifact transformed as the second artifact, and program code for generating a new integrated version of the second artifact having a merge of the elements in the first and second temporary versions of the second artifact.

In another aspect, the invention features an apparatus for merging artifacts in a parallel development of a first artifact and a second artifact. The first and second artifacts are interdependent semi-derived artifacts each having a plurality of elements. The apparatus includes means for generating a temporary version of the first artifact having a merge of elements from a local version of the first artifact to be delivered to an integration stream and a latest integrated version of the first artifact, and means for generating a first temporary version of the second artifact having all the elements of a latest integration version of the second artifact and all the elements of the temporary version of the first artifact transformed as the second artifact. The apparatus also includes means for generating a second temporary version of the second artifact having all the elements of a local version of the second artifact to be delivered to the integration stream and all the elements of the temporary version of the first artifact transformed as the second artifact, and means for generating a new integrated version of the second artifact having a merge of the elements in the first and second temporary versions of the second artifact.

### BRIEF DESCRIPTION OF THE DRAWINGS

The above and further advantages of this invention may be better understood by referring to the following description in conjunction with the accompanying drawings, in which like numerals indicate like structural elements and features in the various figures. The drawings are not necessarily to scale, emphasis instead being placed upon illustrating the principles of the invention.

FIG. 1 is a functional block diagram depicting a parallel software development environment based on sequential version generation of a software model artifact and a code artifact.

FIG. 2 is a functional block diagram depicting the parallel software development environment of FIG. 1 in which two merge operations are executed to resolve conflicts between similar artifacts.

FIG. 3 is a functional block diagram depicting a parallel software development environment utilizing an embodiment of a method for merging artifacts in accordance with the invention.

FIG. 4 is a flowchart representation of an embodiment of a method for merging artifacts for a parallel development of interdependent semi-derived artifacts in accordance with the invention.

FIG. 5 is a flowchart representation of an embodiment of a reverse engineering operation in accordance with the invention.

FIG. 6 is a flowchart representation of an embodiment of a forward engineering operation in accordance with the invention.

FIG. 7 is a functional block diagram depicting a parallel software development environment utilizing another embodiment of a method for merging artifacts in accordance with the invention.

FIG. 8 is a flowchart representation of another embodiment of a method for merging artifacts for a parallel development of interdependent semi-derived artifacts in accordance with the invention.

### DETAILED DESCRIPTION

In brief overview the present invention relates to a method for merging artifacts in a parallel development of interdependent semi-derived artifacts (SDAs). A combination of forward engineering, reverse engineering and merge operations are used to avoid duplication in resolving conflicting semantic changes. Delivery of the artifacts to an integration stream includes making local changes to the artifacts visible to users of the integration stream and allows intermediate merge operations to be performed.

As used herein, an SDA means an artifact (i.e., file) that is generated in part through a transformation and in part through direct editing. For example, a third-generation language (3GL) code file (e.g., Java file) can be generated from a software modeling tool (e.g., UML) and then edited by a programmer. A forward engineering tool operates on the primary artifact to generate the SDA. In this example, the software model is the primary artifact, the forward engineering tool applies the transformation, and the 3GL code is the SDA.

A primary artifact can also be an SDA. In an illustrative example, a software model and a 3GL code file are used in a “round trip” engineering workflow. When a forward engineering operation is used, the software model is the primary artifact and the 3GL code file is the SDA. Conversely, when a reverse engineering operation is used, the 3GL code file is the primary artifact and the software model is the SDA. Stated otherwise, the software model is “linked” with the 3GL code file as primary artifact and SDA, or SDA and primary artifact, depending on the particular engineering operation applied. Thus the software model and the 3GL file are interdependent SDAs.

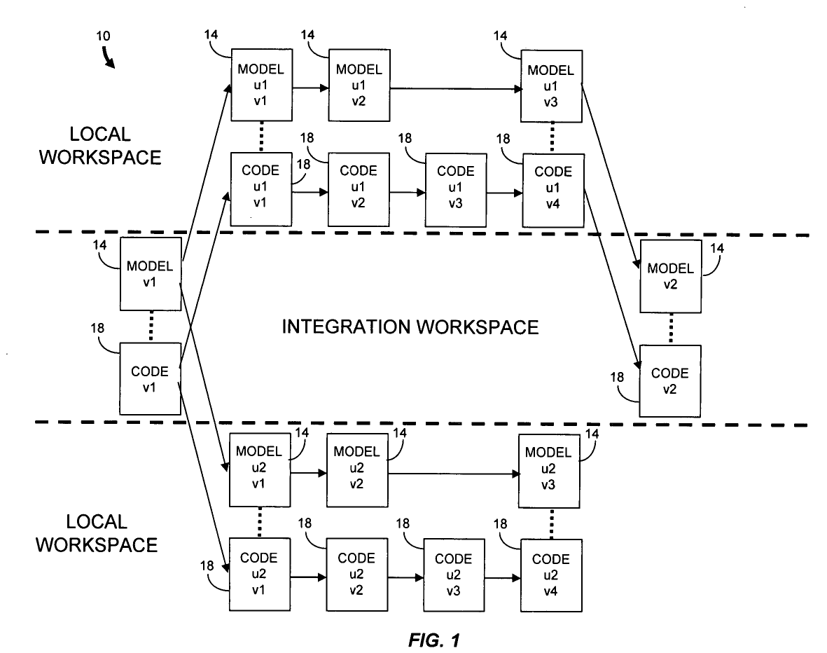

FIG. 1 is an example of a software development environment 10 based on a round trip engineering workflow in which interdependent software model and code artifacts 14 and 18, respectively, are concurrently modified. Each artifact 14, 18 is shown with a corresponding user number un in which n identifies a specific user or developer. Similarly, each artifact 14, 18 is shown with a version number vn in which n represents the version in the sequence. A source control management (SCM) system tracks the artifact versions and links the synchronized versions in the integration workspace (i.e., integration stream) depicted between the dashed lines in the figure. Vertical dashed lines indicate that the connected software model and code artifacts 14, 18 are synchronized. Thus any synchronization operation applied to previously synchronized artifacts 14, 18 does not result in changes to the artifacts 14, 18. As used hereafter, reference to a particular instance of an artifact 14, 18 is made according to its type (i.e., model or code), user number (if applicable) and version number.

Synchronized artifacts model v1 and code v1 are modified in a local workspace by a developer (u1). Model v1 is modified two times, resulting in model versions u1 v2 and u1 v3, and the code v1 is modified three times, resulting in code versions u1 v2, u1 v3 and u1 v4. Model u1 v3 and code u1 v4 are synchronized in the local workspace before delivery to the integration workspace as synchronized model v2 and code v2. Concurrently and independently, synchronized artifacts model v1 and code v1 are modified in another local workspace by a second developer (u2). Model v1 is modified twice, resulting in model versions u2 v2 and u2 v3, and the code v1 is modified three times, resulting in code versions u2 v2, u2 v3 and u2 v4. Model u2 v3 and code u2 v4 are synchronized in the local workspace of the second developer but are not shown as delivered to the integration workspace.

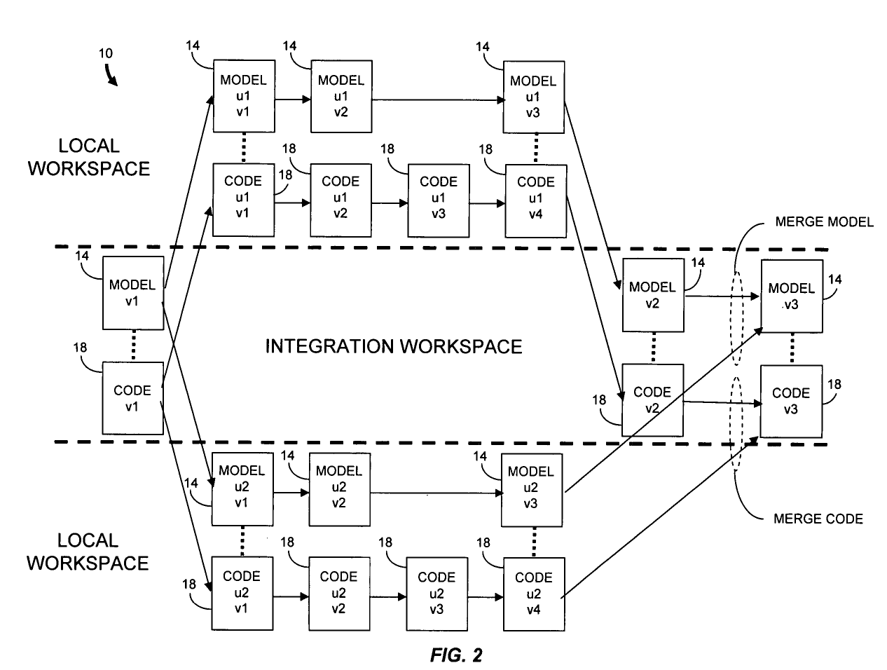

FIG. 2 illustrates the delivery of locally synchronized model u2 v3 and code u2 v4 to the integration workspace subsequent to the delivery of locally synchronized model u1 v3 and code u1 v4. Local model u2 v3 is merged with model v2 to generate model v3. Similarly, local code u2 v4 is merged with code v2 to generate code v3 which is in synchronization with model v3. Dashed ovals identify the input artifacts 14, 18 and output artifacts 14, 18 for the model merge and code merge operations.

Two merge operations are performed upon delivery of the model u2 v3 and code u2 v4 by the second developer u2 to the integration workspace, thus the same conflicts are resolved twice; once for the model artifacts and once for the code artifacts. If numerous changes are made by one or both developers (u1 and/or u2), significant processing and user intervention occurs in the duplicate resolution of the same logical conflicts. As an example of a single conflict, the first developer renames a nested class in the model v1 and synchronizes the code artifact 18 to include this change. The second developer u2 deletes the same nested class from the model v1 and synchronizes the code artifact 18 to include this change. When merging model v2 and model u2 v3, the second developer u2 resolves a delete/change conflict. In addition, when merging code v2 and code u2 v4, the second developer u2 resolves delete/change line conflicts. Thus the second developer u2 is presented with an inefficient process for resolving conflicts upon delivery of model and code artifacts 14, 18 to the integration workspace.

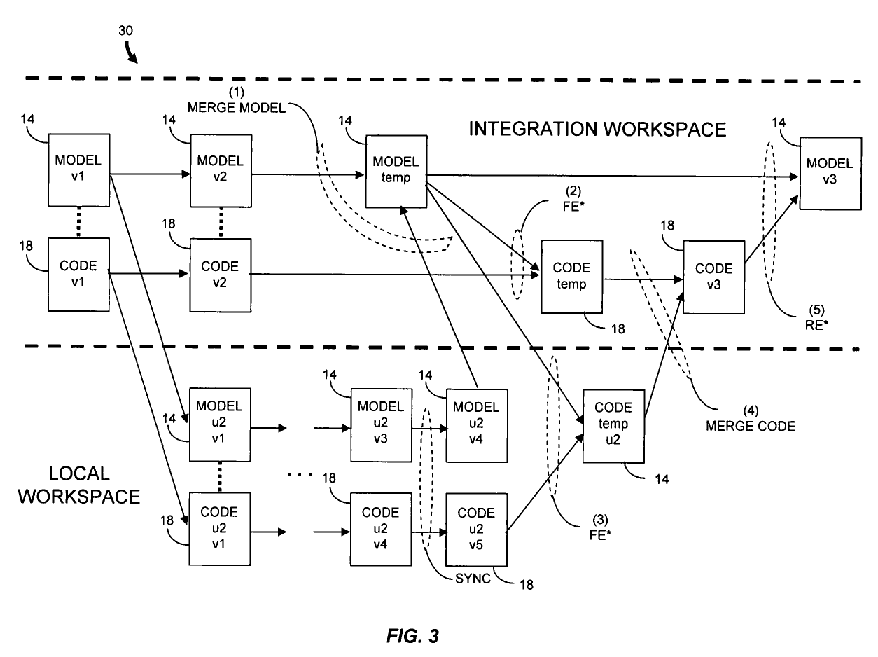

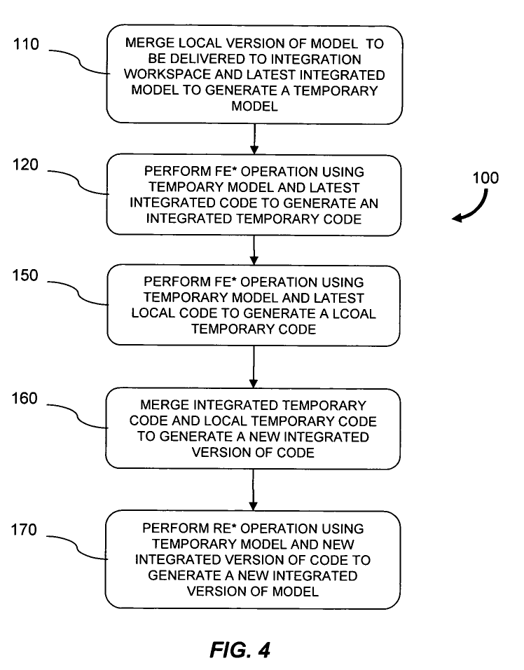

FIG. 3 illustrates a software development environment 30 based on an embodiment of a method 100 illustrated in FIG. 4 for merging artifacts according to the principles of the invention. Models v1 and v2 and code v1 and v2 represent the same model and code artifacts 14, 18 as depicted in FIG. 1 and FIG. 2, thus the local workspace of the first developer u1 is omitted from FIG. 3 for clarity. Dashed ovals indicated the input artifacts 14, 18 and output artifacts 14, 18 for merge operations, modified forward engineering operations FE* and a modified reverse engineering operation RE* as described below. A parenthetical reference associated with each dashed oval indicates the order of execution of the respective operation.

The delivery operation is based on making local changes to model and code artifacts 14, 18 visible to users of the integration workspace for merge operations as necessary. Prior to delivery, the local versions of the model 14 and code 18 are synchronized and the model 14 and code 18 in the integration workspace are synchronized. The delivered model (model v3) and delivered code (code v3) resulting from the method of the invention are synchronized as a result of the operations applied as described below.

The method 100 includes merging (step 110) a local version of the model to be delivered to the integration stream (model u2 v4) and the latest integrated model (model v2) to create a temporary model (model temp). Conflicts are resolved by the developer using a merge tool. An integrated temporary code (code temp) is generated by performing (step 120) a modified forward engineering operation FE* on the temporary model (model temp) and the latest integrated code (code v2). No conflicts occur as a result of the modified forward engineering operation because changes occur only on the model side. The modified forward engineering operation FE* differs from a standard forward engineering operation because the target artifact is not created from scratch. Instead, the modified forward engineering operation FE* modifies a copy of the source artifact to avoid the loss of any non-derived data.

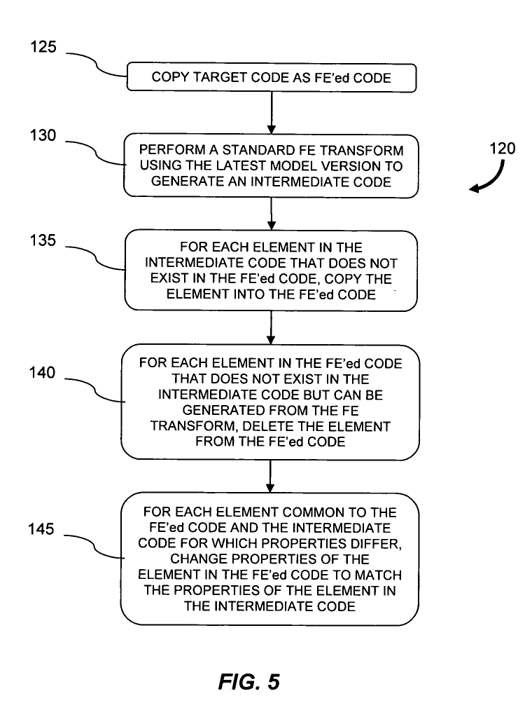

FIG. 5 illustrates the modified forward engineering operation FE* 120 in more detail. According to the illustrated embodiment, a forward engineering code is created by copying (step 125) the target code (code v2). A standard forward engineering operation is performed (step 130) using the latest model version (model temp) to generate an intermediate code. Each element in the intermediate code that is not in the forward engineering code is copied (step 135) into the forward engineering code. Each element in the forward engineering code that is not in the intermediate code but can be generated from the forward engineering operation is deleted (step 140) from the forward engineering code. If the properties of elements common to the forward engineering code and the intermediate code differ, the properties of the elements in the forward engineering code are changed (step 145) to be the same as the properties of the corresponding elements in the intermediate code. The resulting forward engineering code is the output code (code temp) for the modified engineering operation FE*.

Referring again to FIG. 3 and FIG. 4, the method 100 also includes generating a local temporary code (code temp u2) by performing (step 150) the modified forward engineering operation FE* on the temporary model (model temp) and the latest version of the local code (code u2 v5). This second modified forward engineering operation FE* is similar to the engineering operation described for FIG. 5 but one of the input artifacts is different and therefore the output artifact is also different. Again, no conflicts occur as a result of the modified forward engineering operation FE* because changes occur only on the model side. Subsequently, the integrated temporary code (code temp) and the local temporary code (code temp u2) are merged (step 160) to create a new integrated (i.e., delivered) version of code (code v3). Only new conflicts, i.e., conflicts that were not managed in step 110, are addressed in step 160. A new integrated (i.e., delivered) version of the model (model v3) is generated by performing (step 170) a modified reverse engineering operation RE* on the temporary model (model temp) and the new integrated version of code (code v3). Step 170 manages manual changes that occur during step 160 which affect the new integrated model (model v3) and ensures synchronization of the new integrated version of the model (model v3) the new integrated version of code (code v3). No conflicts are encountered because changes occurred only on the code side.

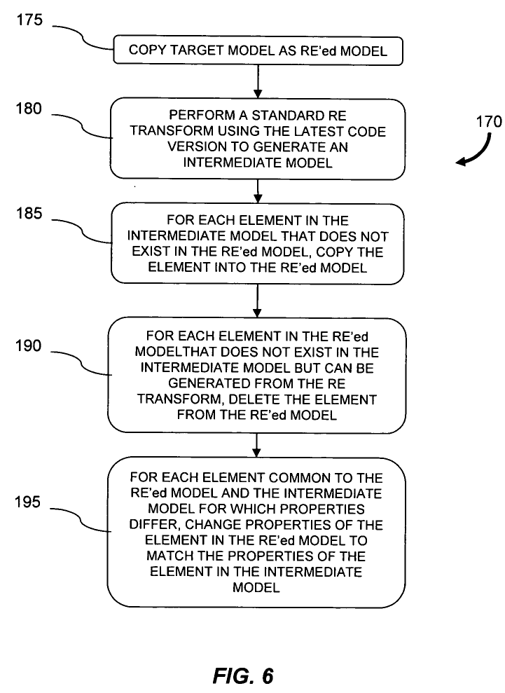

FIG. 6 illustrates the modified reverse engineering operation RE* 170 in more detail. A reverse engineering model is created by copying (step 175) the target model (model temp). A conventional reverse engineering operation is performed (step 180) using the latest code version (code v4) to generate an intermediate model. Each element in the intermediate model that is not in the reverse engineering model is copied (step 185) into the reverse engineering model. Each element in the reverse engineering model that is not in the intermediate model but can be generated from the reverse engineering operation is deleted (step 190) from the reverse engineering model. There can be common elements in the reverse engineering model and the intermediate model but the properties of such elements can differ. The properties of such elements in the reverse engineering model are changed (step 195) to be the same as the properties of the corresponding elements in the intermediate model. The resulting reverse engineering model represents the output model (model v3) for the modified engineering operation FE*.

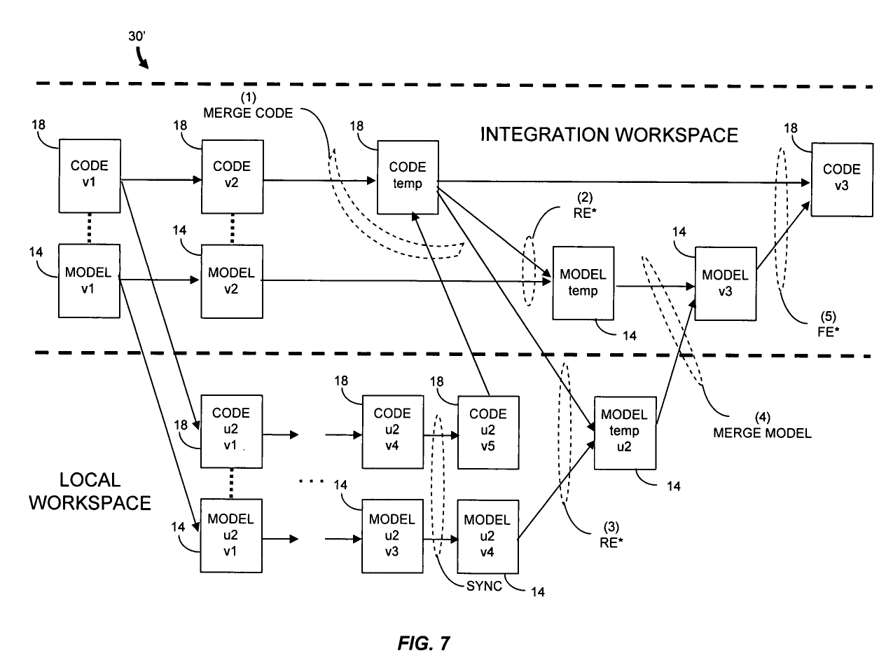

The above description of a method 100 for merging artifacts in a parallel development environment 10 as shown in FIG. 3 is based on a prescribed order of merge operations and modified forward and reverse engineering operations FE*, RE*. Referring to FIG. 7, a complementary parallel development environment 30′ is shown in which the application of the merge and modified engineering operations FE*, RE* is reversed. This alternative embodiment of the method of the invention can be favored, for example, depending on particular implementations of the engineering operations and merge tools.

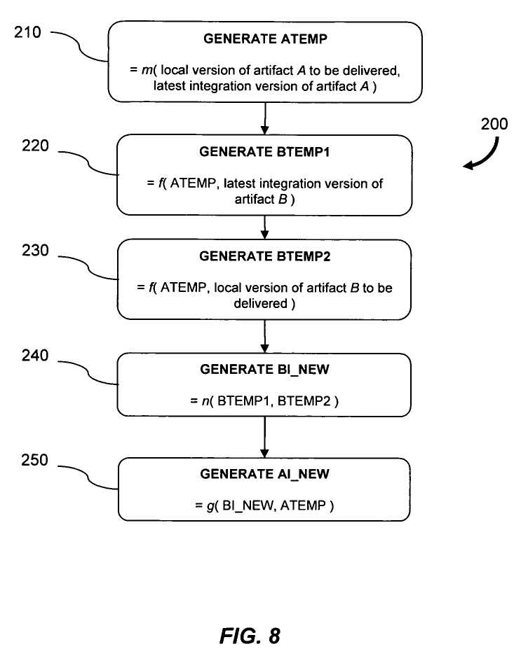

The above description relates to the development of software models and code, however, the method for merging artifacts according to the invention can be generalized to any two interdependent semi-derived artifacts A and B as represented in the flowchart of FIG. 8. Examples of interdependent semi-derived artifacts, other than model and code artifacts, include models used to generate other models, code used to generate other code, hyper text markup language (HTML) generated from a word processor document, and Javadoc and Java code.

According to the generalized method 200, a first transformation function ƒ given by
ƒ(a,b):A×B→B
generates an artifact of type B that contains all the elements of b that are independent of a and all the elements of a transformed as B. The modified forward engineering operation FE* described above is one example of the first transformation function ƒ. A second transformation function g given by
g(b,a): B×A→A
generates an artifact of type A that contains all the elements of a that are independent of b and all the elements of b transformed as A. The modified reverse engineering operation RE* described above is one example of the second transformation function g. A merge operation m given by
m(a₁, a₂):A×A→A
generates an artifact of type A that contains a merge of elements from a₁ and a₂ and a merge operation n given by
n(b₁, b₂): B×B→B
generates an artifact of type B that contains a merge of elements from b₁ and b₂.

The method includes generating (step 2 1 0) a temporary artifact ATEMP by applying the merge operation m on a local version of artifact A to be delivered to an integration stream and a latest integrated version of artifact A. A first temporary version of artifact B (BTEMP1) is generated (step 220) by applying the first transformation ƒ to the temporary artifact ATEMP and the latest integrated version of artifact B. A second temporary version of artifact B (BTEMP2) is generated (step 230) by applying the first transformation ƒ to the temporary artifact ATEMP and the local version of artifact B to be delivered to the integration stream. A new integrated version of artifact B (BI_NEW) is generated (step 240) by applying the merge operation n on the first and second temporary versions of artifact B. The second transformation g is applied to the new integrated version of artifact B and the temporary artifact ATEMP to generate (step 250) a new integrated version of artifact A (AI_NEW) that is synchronized with the new integrated version of artifact B (BI_NEW).

While the invention has been shown and described with reference to specific embodiments, it should be understood by those skilled in the art that various changes in form and detail may be made therein without departing from the spirit and scope of the invention.

1. A method for merging artifacts in a parallel development of a first artifact and a second artifact, the first and second artifacts being interdependent semi-derived artifacts each having a plurality of elements, the method comprising:
generating a temporary version of the first artifact having a merge of elements from a local version of the first artifact to be delivered to an integration stream and a latest integrated version of the first artifact;
generating a first temporary version of the second artifact having all the elements of a latest integration version of the second artifact and all the elements of the temporary version of the first artifact transformed as the second artifact;
generating a second temporary version of the second artifact having all the elements of a local version of the second artifact to be delivered to the integration stream and all the elements of the temporary version of the first artifact transformed as the second artifact; and
generating a new integrated version of the second artifact having a merge of the elements in the first and second temporary versions of the second artifact.

2. The method of claim 1- further comprising generating a new integrated version of the first artifact having all the elements of the temporary version of the first artifact and all the elements of the new integrated version of the second artifact transformed as the first artifact, wherein the new integrated version of the first artifact is synchronized with the new integrated version of the second artifact.

3. The method of claim 1 wherein one of the first and second artifacts is a software model artifact and the other of the first and second artifacts is a code artifact.

4. The method of claim 3 wherein the software model artifact is a UML file.

5. The method of claim 3 wherein the code artifact is a 3GL source file.

6. The method of claim 1 wherein the generating of the first temporary version of the second artifact comprises performing one of a modified forward engineering operation and a modified reverse engineering operation.

7. The method of claim 6 wherein the generating of the second temporary version of the second artifact comprises performing the other of a modified forward engineering operation and a modified reverse engineering operation.

8. The method of claim 2 wherein the generating of the new integrated version of the first artifact comprises performing one of a modified forward engineering operation and a modified reverse engineering operation.

9. A computer program product for use with a computer system, the computer program product comprising a computer useable medium having embodied therein program code for processing integrated versions and local versions of a first artifact and a second artifact, the first and second artifacts being interdependent semi-derived artifacts each having a plurality of elements, the program code comprising:
program code for generating a temporary version of the first artifact having a merge of elements from a local version of the first artifact to be delivered to an integration stream and a latest integrated version of the first artifact;
program code for generating a first temporary version of the second artifact having all the elements of a latest integration version of the second artifact and all the elements of the temporary version of the first artifact transformed as the second artifact;
program code for generating a second temporary version of the second artifact having all the elements of a local version of the second artifact to be delivered to the integration stream and all the elements of the temporary version of the first artifact transformed as the second artifact; and
program code for generating a new integrated version of the second artifact having a merge of the elements in the first and second temporary versions of the second artifact.

10. The computer program product of claim 9 further comprising program code for generating a new integrated version of the first artifact having all the elements of the temporary version of the first artifact and all the elements of the new integrated version of the second artifact transformed as the first artifact, wherein the new integrated version of the first artifact is synchronized with the new integrated version of the second artifact.

11. The computer program product of claim 9 wherein one of the first and second artifacts is a software model artifact and the other of the first and second artifacts is a code artifact.

12. The computer program product of claim 9 wherein the generating of the first temporary version of the second artifact comprises performing one of a modified forward engineering operation and a modified reverse engineering operation.

13. The computer program product of claim 12. wherein the generating of the second temporary version of the second artifact comprises performing the other of a modified forward engineering operation and a modified reverse engineering operation.

14. The method of claim 10 wherein the generating of the new integrated version of the first artifact comprises performing one of a modified forward engineering operation and a modified reverse engineering operation.

15. A computer data signal embodied in a carrier wave for use with a computer system, the computer data signal comprising program code for processing integrated versions and local versions of a first artifact and a second artifact, the first and second artifacts being interdependent semi-derived artifacts each having a plurality of elements, the program code comprising:
program code for generating a temporary version of the first artifact having a merge of elements from a local version of the first artifact to be delivered to an integration stream and a latest integrated version of the first artifact;
program code for generating a first temporary version of the second artifact having all the elements of a latest integration version of the second artifact and all the elements of the temporary version of the first artifact transformed as the second artifact;
program code for generating a second temporary version of the second artifact having all the elements of a local version of the second artifact to be delivered to the integration stream and all the elements of the temporary version of the first artifact transformed as the second artifact; and
program code for generating a new integrated version of the second artifact having a merge of the elements in the first and second temporary versions of the second artifact.

16. The computer data signal of claim 15 further comprising program code for generating a new integrated version of the first artifact having all the elements of the temporary version of the first artifact and all the elements of the new integrated version of the second artifact transformed as the first artifact, wherein the new integrated version of the first artifact is synchronized with the new integrated version of the second artifact.

17. The computer data signal of claim 15 wherein one of the first and second artifacts is a software model artifact and the other of the first and second artifacts is a code artifact.

18. The computer data signal of claim 15 wherein the generating of the first temporary version of the second artifact comprises performing one of a modified forward engineering operation and a modified reverse engineering operation.

19. The computer data signal of claim 18 wherein the generating of the second temporary version of the second artifact comprises performing the other of a modified forward engineering operation and a modified reverse engineering operation.

20. The computer data signal of claim 16 wherein the generating of the new integrated version of the first artifact comprises performing one of a modified forward engineering operation and a modified reverse engineering operation.

21. An apparatus for merging artifacts in a parallel development of a first artifact and a second artifact, the first and second artifacts being interdependent semi-derived artifacts each having a plurality of elements, the apparatus comprising:
means for generating a temporary version of the first artifact having a merge of elements from a local version of the first artifact to be delivered to an integration stream and a latest integrated version of the first artifact;
means for generating a first temporary version of the second artifact having all the elements of a latest integration version of the second artifact and all the elements of the temporary version of the first artifact transformed as the second artifact;
means for generating a second temporary version of the second artifact having all the elements of a local version of the second artifact to be delivered to the integration stream and all the elements of the temporary version of the first artifact transformed as the second artifact; and
means for generating a new integrated version of the second artifact having a merge of the elements in the first and second temporary versions of the second artifact.

22. The apparatus of claim 21 further comprising means for generating a new integrated version of the first artifact having all the elements of the temporary version of the first artifact and all the elements of the new integrated version of the second artifact transformed as the first artifact, wherein the new integrated version of the first artifact is synchronized with the new integrated version of the second artifact.
